(19) United States
(12) Patent Application Publication
(10) Pub. No.: US 2005/0282922 A1
(43) Pub. Date: Dec. 22, 2005

(54) Extruded polystyrene resin foam

(75) Inventors: Hisao Nakamura, Kanuma-shi (JP); Yoshihiko Kanda, Kanuma-shi (JP); Tatsuya Kimura, Kanuma-shi (JP)

Correspondence Address: KANESAKA BERNER AND PARTNERS LLP, SUITE 300, 1700 DIAGONAL RD, ALEXANDRIA, VA, 22314-2848, US

(73) Assignee: JSP CORPORATION, Tokyo (JP)

(21) Appl. No.: 11/141,045

(22) Filed: Jun. 1, 2005

(30) Foreign Application Priority Data
Jun. 1, 2004 (JP) 2004-163334

(51) Int. Cl. C08F 2/00

(52) U.S. Cl. 521/142

(57) ABSTRACT

A thick extruded polystyrene resin foam which can be obtained without using chlorofluorohydrocarbons has a center portion in which the cells are approximately spherical. The extruded polystyrene resin foam contains a residual gas selected from fluorohydrocarbons, aliphatic hydrocarbons and alicyclic hydrocarbons, and has a thickness of 45 to 150 mm and an apparent density of 0.015 to 0.06 g/cm³. The resin foam includes a center layer, excluding 10% of the foam thickness from each of the two foam surfaces, which is composed of cells with specific shape and compressive strengths in the foam thickness, transverse and machine directions.

### BACKGROUND OF THE INVENTION

1. Field of the Invention

The present invention relates to extruded polystyrene resin foams, and more particularly to thick extruded polystyrene resin foams having a center portion composed of cells that are approximately spherical in shape, good thermal insulating properties and dimensional stability, and excellent compressive strength uniformity in the machine transverse and thickness directions.

2. Description of the Related Art

Polystyrene resin foams are widely used in many fields. Thick foams of this type are employed in a variety of construction and civil engineering-related applications, including building insulation, refrigerator truck insulation, core materials in flooring and tatami mats, vibration insulators, water drainage materials, soil mounding materials and backfilling materials.

Extruded polystyrene resin foams are manufactured by extruding a blowing agent-containing expandable resin melt from a die mounted on an extruder, and causing the extruded melt to move along the inner walls of a guider provided at the top and bottom with plate-like members or belts. In an extruded polystyrene resin foam obtained in this way, cells that are located near the surfaces of the foam have shapes that are elongated in the machine direction. Whereas cells near the center of the foam cross-section have shapes that are much more elongated in the thickness direction than the cells near the surfaces. This tendency becomes increasingly pronounced as the foam becomes thicker.

Foams in which the shapes of the cells are elongated in the thickness direction in this way have a high compressive strength in the thickness direction, but have a low compressive strength in the machine and transverse directions. Moreover, such foams break easily when bent in the machine direction or transverse direction. Hence, a drawback of such foams is that their strength varies with the direction of use.

In extruded polystyrene resin foams, when the cell shapes are elongated in the thickness direction, the foam has a high compressive strength but tends to have poor thermal insulating properties and dimensional stability. When the cells are longer in the machine direction and/or transverse direction, the expanded material tends to have a poor compressive strength. Therefore, a foam in which the shape of the cells is approximately spherical would have an excellent flexural strength and compressive strength uniformity in all directions, and would also have good thermal insulating properties and good dimensional stability.

In the prior art, Japanese Patent Application Laid-open No. H4-189526 focuses on properties such as the cell diameter and cell shape in relatively thick extruded polystyrene resin foams and teaches that certain high compressive-strength styrene resin foams, such as those which have a thickness of 10 to 50 mm, a density of 25 to 35 kg/m³, and an average cell diameter in the machine direction, excluding 1 mm thick skin regions, which is larger than the average cell diameters in the transverse and thickness directions, the ratio therebetween being in a range of 1.2 to 2.0 and gradually approaching 1 as the center of the expanded material in the thickness direction is approached, are advantageous for use as the core material in tatami mats.

Japanese Patent Application Laid-open No. S56-10434 discloses a polystyrene resin foam plank in which cells at the ends of the plank in the transverse direction differ in structure from cells in other regions. More specifically, this prior art provides an extruded polystyrene resin foam plank for use in tatami mats, which foam plank has a density of 25 to 50 kg/m³ and an average cell diameter of 1 mm or less, wherein portions from either end of the plank in the transverse direction which account for at least 2% of the full width have an average thickness direction cell diameter (a) to average transverse direction cell diameter (b) ratio a/b≧1.10 and an average thickness direction cell diameter (a) to average machine direction cell diameter (c) ratio a/c≧1.10, and other portions of the plank have an average thickness direction cell diameter (a′) to average transverse direction cell diameter (b′) ratio a′/b′≧0.70 and an average thickness direction cell diameter (a′) to average machine direction cell diameter (c′) ratio a′/c′≧0.70, with a′/b′<a/b and a′/c′<a/c.

However, the extruded polystyrene resin foams of Japanese Patent Application Laid-open No. H4-189526 are characterized in that cells in the portions of the foam that exclude the skin regions have an average cell diameter in the machine direction which is larger than the average cell diameters in the transverse and thickness directions, the ratio therebetween being 1.2 to 2.0; that is, the cells have shapes that are elongated in the machine direction. Although the foam is indicated as having a thickness of 10 to 50 mm, in the examples provided to illustrate the invention, only a thickness of 25 mm is actually mentioned. No specific mention is made of foams having a thickness greater than 45 mm. As for the foam described in Japanese Patent Application Laid-open No. S56-10434, this has cell shapes which are elongated in the thickness direction (see, for example, lines 10 and 11 in the right-hand column on page 2 of the laid-open application). The thickness of the foam, while not specified, is presumably about 28 mm based on descriptions given in the examples of the invention. Here too, no mention is made of any foams having a thickness greater than 45 mm.

Japanese Utility Model Publication No. H2-25863 describes a core material for tatami mats that is made of extruded polystyrene resin foam wherein the shape of cells in a thickness cross-section is elongated in the transverse and/or machine directions within top and bottom surface layers and is elongated in the thickness direction within a center layer. The foam has a 5% compressive strength of at least 2.0 kg/cm² but less than 3.0 kg/cm², and a 10% compressive strength of at least 2.5 kg/cm². This prior-art extruded foam which is used as a core material for tatami mats has an improved compressive strength owing to the difference in cell shape between top and bottom surface layers of the foam and the center layer.

However, Japanese Utility Model Publication No. H2-25863 makes no mention of a thick extruded polystyrene resin foam having a thickness of more than 45 mm in which the cells near the center of the foam are substantially spherical in shape.

Japanese Patent Application Laid-open No. H11-170331 discloses a method of manufacturing a foam body wherein an expanded layer is formed integral with surface layers by multilayer extrusion foaming. A torpedo is placed within the die to narrow the resin flow channel and increase resin pressure within the die. The resin is discharged from the die orifice into a sizer, and the core layer (expanded layer) is allowed to swell outward, i.e., toward the surface layers, to form a multilayer extruded foam body which has surface layers and in which the core layer (expanded layer) and the surface layer are united.

Japanese Patent Publication No. S47-47096 discloses a process for manufacturing composite bodies made of an extruded polystyrene resin foam having skin layers and an inner expanded layer. A sizer of the same shape and dimensions as the extrudate is connected to the outlet of a die equipped with a torpedo, the relative positions of the die outlet face and the torpedo outlet face are varied by moving either the die or the torpedo, and the resin is extruded and expanded, giving an expanded product of the desired surface layer thickness.

However, both Japanese Patent Application Laid-open No. H11-170331 and Japanese Patent Publication No. S47-47096 relate in fact to extruded foams to be used as artificial woods having an apparent density of about 0.7 g/cm³ or more, and methods for the production thereof. Neither of these prior-art publications makes any mention whatsoever of the extruded polystyrene resin foam of the present invention which is a thick extruded foam of low apparent density having a thickness of more than 45 mm wherein the cells are of a substantially spherical shape.

In the relatively thick extruded polystyrene resin foams of the prior art, the cells near the surface have shapes which are elongated in the machine direction and the cells near the center have shapes which, in a cross-section perpendicular to the machine direction, are elongated in the thickness direction. Such foams have a high compressive strength in the thickness direction, but have a low flexural strength in the machine and transverse directions and also have a poor dimensional stability.

Physical blowing agents that were formerly used for obtaining extruded polystyrene resins include chlorofluorohydrocarbons such as dichlorodifluoromethane and 1,1-dichloro-1-fluoroethane, but the use of these chemicals is restricted today due to the problem of ozone layer depletion. Over the past few years, various physical blowing agents have been proposed as substitutes for chlorofluorohydrocarbons, but none has a performance as a physical blowing agent that matches the performance of chlorofluorohydrocarbons. For example fluorohydrocarbons with an ozone depletion potential of zero have a poor solubility in styrene resins, making foams with a low apparent density and a high thickness difficult to obtain. Aliphatic hydrocarbons such as butane have also been studied as physical blowing agents for use in place of chlorofluorohydrocarbons, but these blowing agents remain within the resulting foam. Because aliphatic hydrocarbons are flammable substances, the amount used clearly must be limited to meet fire retardance standards in extruded polystyrene resin foams. As a result, foams having a low apparent density and a high thickness are difficult to obtain using such blowing agents. Under these circumstances, to obtain an extruded polystyrene resin foam having a high thickness, production must be carried out by maximizing the foaming ability of the expandable resin melt composed of the physical blowing agent and the polystyrene resin so as to induce expansion to occur up to a point just short of cell collapse. As a result, in the cellular structure of the foam thus obtained, cells near the center of the foam will have a shape that is elongated in the thickness direction. Hence, among extruded polystyrene resin foams obtained without the use of chlorofluorohydrocarbons, no extruded polystyrene resin foams have until now had an apparent density of 0.015 to 0.06 g/cm³, a thickness greater than 45 mm, and a cell shape near the center of the expanded layer which is substantially spherical.

### SUMMARY OF THE INVENTION

It is therefore an object of the present invention to provide extruded polystyrene resin foams which can be obtained without using chlorofluorohydrocarbons as the blowing agent, which have a thickness of at least 45 mm and an apparent density of 0.015 to 0.06 g/cm³, and in which the cells near the center of the expanded layer have a shape that is substantially spherical, particularly extruded polystyrene resin foams endowed with excellent uniformity in the mechanical properties required of thick foams, such as compressive strength, and with excellent dimensional stability so that little dimensional change occurs due to the shrinkage with elapse of the time that is so pronounced in thick foams.

Accordingly, the present invention provides an extruded polystyrene resin foam which is obtained without using chlorofluorohydrocarbons as the blowing agent, which has a thickness of at least 45 mm, which includes a center layer, exclusive of portions accounting for 10% of the foam thickness from each of two foam surfaces, composed of cells with a shape that satisfies specific conditions, which has excellent uniformity of compressive strength in the thickness direction, transverse direction and machine direction, and which also has excellent thermal insulating properties and dimensional stability.

More specifically, the present invention provides an extruded polystyrene resin foam which contains a residual gas selected from fluorohydrocarbons, aliphatic hydrocarbons and alicyclic hydrocarbons and has a thickness of 45 to 150 mm and an apparent density of 0.015 to 0.06 g/cm³, and the foam has a center layer which, exclusive of portions accounting for 10% of the foam thickness from each of two foam surfaces, is composed of cells with a shape that satisfies formulae (1) and (2) below, and has compressive strengths in foam thickness, transverse and machine directions which satisfy formulae (3) to (5) below.
0.80≦D_{VD}/D_{TD}<1.20 (1)
0.80≦D_{VD}/D_{MD}<1.20 (2)
0.65≦(P_{VD}+P_{TD}+P_{MD})/3P_{VD}≦1.40 (3)
0.80≦(P_{VD}+P_{TD}+P_{MD})/3P_{TD}≦1.50 (4)
0.80≦(P_{VD}+P_{TD}+P_{MD})/3P_{MD}≦1.50 (5)
Here, D_{VD} is the average diameter of cells within the center layer in the thickness direction, D_{TD} is the average diameter of cells within the center layer in the transverse direction, D_{MD} is the average diameter of cells within the center layer in the machine direction, P_{VD} is the compressive strength of the foam in the thickness direction, P_{TD} is the compressive strength of the foam in the transverse direction, and P_{MD} is the compressive strength of the foam in the machine direction.

The extruded polystyrene resin foam of the present invention is characterized in that the center layer, within a cross-section perpendicular to the machine direction, has an average cell diameter in the thickness direction for the center layer as a whole of from 70 to 700 μm and includes at least one microcellular layer having an average cell diameter in the thickness direction within the center layer that is from 50 to 500 μm and less than the average cell diameter in the thickness direction for the center layer as a whole.

The extruded polystyrene resin foam of the present invention is also characterized by containing no residual gases comprising fluorohydrocarbons in the foam.

The extruded polystyrene resin foam of the present invention is additionally characterized by having a thermal conductivity of 0.02 to 0.04 W/m·K and a compressive strength in the thickness direction of 0.15 to 0.80 N/mm².

The extruded polystyrene resin foam with a thickness of 45 to 150 mm and an apparent density of 0.015 to 0.06 g/cm³ of the present invention is preferably obtained by introducing an expandable resin melt, which is prepared by melting and mixing together a polystyrene resin, additives and a blowing agent within an extruder, into a die, which has a cooling member therein and is configured so that a molten resin flow channel within the die is broad in a vertical direction but narrows abruptly near a die orifice, and by extrusion foaming the melt by discharging it from the die orifice into a mould attached to a tip of the die, wherein the foam comprises a center layer which, exclusive of portions accounting for 10% of the foam thickness from each of two foam surfaces, is composed of cells with a shape that satisfies formulae (1) and (2) above, and has compressive strengths in foam thickness, transverse and machine directions which satisfy formulae (3) to (5) above.

The extruded polystyrene resin foam of the present invention (sometimes referred to below as simply the “extruded foam”) is an extruded foam plank of a large thickness and a small apparent density which has a center layer wherein the cells are of substantially spherical shape, which has excellent compressive strength uniformity in the thickness, transverse and machine directions, and which has good thermal insulating properties and dimensional stability.

Moreover, the extruded foam of the present invention is an extruded polystyrene resin foam endowed with a thermal conductivity and a compressive strength that are particularly outstanding.

The extruded foam of the present invention, which can be used directly as is or after slicing to the desired shape, is useful in such applications as construction and civil engineering materials, including building insulation, insulation for refrigerator trucks, core material in flooring and tatami mats, vibration insulators, water drainage materials, soil mounding materials and backfilling materials.

### BRIEF DESCRIPTION OF THE DRAWINGS

FIG. 1 is a partial longisectional view showing an example of a die construction that may be used in the manufacture of the extruded polystyrene resin foam of the present invention; and

FIG. 2 is a partial longisectional view showing the die construction in an arrangement for manufacturing extruded polystyrene resin foam according to the prior art. In FIG. 1 and FIG. 2, numeral 1 denotes torpedo, 2 denotes die orifice, 3 denotes screw, and 4 denotes die. In FIG. 1, α denotes a lip angle.

### DESCRIPTION OF THE PREFERRED EMBODIMENTS

The present invention relates to a thick extruded polystyrene resin foam plank obtained without using chlorofluorohydrocarbons and having a thickness of 45 to 150 mm. The center layer within the extruded foam has cells of a shape in the thickness direction that is substantially spherical rather than elongated, and has excellent mechanical properties such as compressive strength, excellent thermal insulating properties, and excellent dimensional stability.

Illustrative examples of the polystyrene resin used in the extruded polystyrene resin foam of the present invention include styrene homopolymers and the following copolymers in which styrene is a major component: styrene-acrylic acid copolymers, styrene-methyl acrylate copolymers, styrene-ethyl acrylate copolymers, styrene-methacrylic acid copolymers, styrene-methyl methacrylate copolymers, styrene-ethyl methacrylate copolymers, styrene-maleic anhydride copolymers, styrene-polyphenylene ether copolymers, styrene-butadiene copolymers, styrene-acrylonitrile copolymers, acrylonitrile-butadiene-styrene copolymers, styrene-methylstyrene copolymers, styrene-dimethylstyrene copolymers, styrene-ethylstyrene copolymers and styrene-diethylstyrene copolymers. The styrene content in these styrene copolymers is preferably at least 50 mol %, and most preferably at least 80 mol %.

Other polymers may be mixed with the above polystyrene resin, insofar as the objects and advantages of the present invention can be achieved. Examples of the other polymers include polyethylene resins, polypropylene resins, styrene-butadiene-styrene block copolymers, styrene-isoprene-styrene block copolymers, hydrogenated styrene-butadiene-styrene block copolymers, hydrogenated styrene-isoprene-styrene block copolymers and styrene-ethylene copolymers. Such other polymers may be admixed, according to the intended purpose, in an amount of generally less than 50 wt %, preferably less than 30 wt %, and especially less than 10 wt %.

The use of a polystyrene resin having a melt flow rate (MFR), as measured under test condition 8 in method A of JIS K7210 (1976), of 0.5 to 30 g/10 min, and especially 1 to 10 g/10 min, is preferable for obtaining an extruded foam having an excellent extrusion foamability during foam production and having an excellent appearance and expandability, and for obtaining an extruded foam having also an excellent mechanical strength.

The blowing agent used in the production of the extruded polystyrene resin foam of the present invention is a physical blowing agent, examples of which include organic blowing agents such as aliphatic hydrocarbons, for example propane, n-butane, isobutene, n-pentane, isopentane, alicyclic hydrocarbons, for example cyclopentane, cyclohexane, fluorohydrocarbons, for example 1,1,1,2-tetrafluoroethane, 1,1-difluoroethane, ethers, for example dimethyl ether, diethyl ether, methyl ethyl ether, lower alcohols, for example methanol, ethanol, and chlorinated hydrocarbons, for example methyl chloride, ethyl chloride; and inorganic blowing agents such as carbon dioxide, nitrogen, and air. Two or more of these blowing agents may be used in admixture.

To obtain the extruded polystyrene resin foam of the present invention having a low apparent density, of the above physical blowing agents, it is preferable to use an aliphatic hydrocarbon of 3 to 6 carbons or an alicyclic hydrocarbon of 5 to 6 carbons which has a good solubility in the polystyrene resin and does not have an excessively large plasticizing effect on the polystyrene resin. To obtain the extruded foam having high thermal insulating properties, isobutane and isopentane are preferred as blowing agents which have a good solubility in the polystyrene resin, are capable of providing a foam of low apparent density, and remain within the foam for a long period of time. However, the above aliphatic hydrocarbons and alicyclic hydrocarbons are flammable gases and thus undesirable from the standpoint of the fire retardance of the foam. In particular, although blowing agents such as isobutane and isopentane are highly suitable for obtaining foams having high thermal insulating properties, because they are flammable gases and remain in the foam for a long period of time, they fall short of what is desirable in terms of fire retardance. Therefore, the blowing agent used to obtain the extruded foam of the present invention is preferably a combination of one or more blowing agent selected from among chlorinated hydrocarbons, ethers, alcohols and inorganic gases (referred to below as “early release blowing agents”) with the above-mentioned aliphatic hydrocarbons or alicyclic hydrocarbons.

Concomitant use of the above early release blowing agent is highly desirable because it contributes to expansion during the extrusion foaming process to make a low apparent density of the extruded foam and also helps reduce the amount of flammable gases, such as aliphatic hydrocarbons and alicyclic hydrocarbons, used, thus improving the fire retardance. This early release blowing agent leaves the foam immediately following extrusion foaming or within a short time thereafter. Consequently, an extruded foam having a low apparent density and excellent thermal insulating properties can be obtained without compromising the fire retardance, and the thermal insulating performance and fire retarding performance can be stabilized early on.

The amount of blowing agent added varies empirically with such factors as the type of blowing agent, the apparent density of the target extruded foam, and the type of polystyrene resin, although the amount of addition is generally 0.7 to 2.5 moles, and preferably 0.85 to 2.0 moles, per kilogram of the polystyrene resin. The amount of addition here represents the total number of moles of the constituent blowing agents when a plurality of physical blowing agents are used.

In the extruded foam of the present invention, the residual amount of gases within the foam, and in particular the residual amount of isobutene within the foam, is preferably 0.40 to 0.90 mole, more preferably 0.45 to 0.75 mole, and most preferably 0.50 to 0.65 mole, per kilogram of the foam. A residual amount of isobutene within the above range will result in an extruded foam having high thermal insulating properties. More specifically, by also providing the foam with the subsequently described preferred average cell diameter in the thickness direction of the extruded foam, there can be obtained an extruded foam having a thermal conductivity of 0.028 W/m·K or less which corresponds to a Type 3 extruded polystyrene foam thermal insulation panel according to JIS A9511 (2003).

The levels of residual blowing agent gas within the foam that are mentioned in this specification are measured using a gas chromatograph. Specifically, a sample cut from the center of the extruded foam is placed in a toluene-containing sample bottle equipped with a cap, the cap is closed, and the contents are thoroughly stirred, thereby dissolving the blowing agent present in the extruded foam within the toluene. The resulting measurement sample is then assayed by gas chromatographic analysis using an internal reference, thereby enabling the amount of blowing gases such as isobutane remaining within the foam to be determined.

In an extruded foam obtained using both a blowing agent selected from among the foregoing fluorohydrocarbons, aliphatic hydrocarbons and alicyclic hydrocarbons and the above-described early release blowing agent, as noted above, the early release blowing agent leaves the extruded foam within a short period following production of the foam. The other blowing agent (i.e., fluorohydrocarbon, aliphatic hydrocarbon and alicyclic hydrocarbon) remains within the extruded foam as a residual gas.

The extruded foam of the present invention is not a product obtained using a chlorofluorohydrocarbon as a blowing agent. This is verifiable from the absence of any chlorofluorohydrocarbons as residual gases in the foam because extruded foams obtained using chlorofluorohydrocarbons contain the chlorofluorohydrocarbons as residual gases within the foam.

As mentioned above, the extruded foam of the present invention has a thickness of 45 to 150 mm and an apparent density of 0.015 to 0.06 g/cm³, has a center layer, exclusive of portions accounting for 10% of the foam thickness from each of two foam surfaces, which is composed of cells with a shape that satisfies conditions (1) and (2) below, and has compressive strengths in foam thickness, transverse and machine directions which satisfy conditions (3) to (5) below.
0.80≦D_{VD}/D_{TD}<1.20 (1)
0.80≦D_{VD}/D_{MD}<1.20 (2)
0.65≦(P_{VD}+P_{TD}+P_{VD})/3P_{VD}≦1.40 (3)
0.80≦(P_{VD}+P_{TD}+P_{MD})/3P_{TD}≦1.50 (4)
0.80≦(P_{VD}+P_{TD}+P_{MD})/3P_{MD}≦1.50 (5)
Here, D_{VD} is the average diameter of cells within the center layer in the thickness direction, D_{TD} is the average diameter of cells within the center layer in the transverse direction, D_{MD} is the average diameter of cells within the center layer in the machine direction, P_{VD} is the compressive strength of the foam in the thickness direction, P_{TD} is the compressive strength of the foam in the transverse direction, and P_{MD} is the compressive strength of the foam in the machine direction.

An extruded foam which satisfies above conditions (1) and (2) signifies a foam wherein the cells in the center layer have a shape that is substantially spherical. An extruded foam which satisfies conditions (3) to (5) signifies an extruded foam having a good balance of compressive strength in the foam thickness direction, compressive strength in the foam transverse direction and compressive strength in the foam machine direction.

In the thick extruded foam of the present invention which does not use chlorofluorohydrocarbons, when the ratios in above conditions (1) and (2) are 1.20 or more, the compressive strength in the thickness direction is high, but the compressive strengths in the transverse direction and the machine direction are too low relative to the compressive strength in the thickness direction; moreover, the thermal insulating properties are inadequate. When the ratios in above conditions (1) and (2) are lower than the lower limit of 0.80, the compressive strength in the thickness direction is low, resulting in a poor uniformity of compressive strengths in the thickness direction, transverse direction and machine direction. Moreover, an extruded foam that does not satisfy above conditions (1) and (2) undergoes a large dimensional change following extrusion foaming, giving rise to a shrinkage effect after about 24 hours in which the dimensions at both sides in the machine direction of the extruded foam become smaller than the dimensions of the center portion in the machine direction. Hence, the dimensional stability is poor. In such a case, there will also be a large variability in mechanical properties such as flexural strength in the transverse and machine directions. In the practice of the present invention, the values for D_{VD}/D_{TD} and D_{VD}/D_{MD} are preferably from 0.85 to 1.10. For an extruded foam having even better thermal insulating properties, D_{VD} is more preferably 75 to 350 μm, and even more preferably 80 to 200 μm.

In the extruded foam of the present invention, to achieve physical properties having an even higher degree of uniformity, along with satisfying above conditions (1) and (2), it is preferable for the (cell diameter in thickness direction)/(cell diameter in machine direction) value to be at least 0.80 but less than 1.20 and for the (cell diameter in thickness direction)/(cell diameter in transverse direction) value to be at least 0.80 but less than 1.20 in at least 80% (number basis) of the cells in the center layer present in a vertical cross-section in the machine direction or in a vertical cross-section in the transverse direction.

In above conditions (3) to (5), the value for (P_{VD}+P_{TD}+P_{MD})/3P_{VD} is preferably from 0.75 to 1.35, and more preferably from 0.80 to 1.30, and the values for (P_{VD}+P_{TD}+P_{MD})/3P_{TD} and (P_{VD}+P_{TD}+P_{MD})/3P_{MD} are preferably from 0.85 to 1.35, and more preferably from 0.90 to 1.25. The compressive strength in the thickness direction is preferably from 0.15 to 0.80 N/mm², and more preferably from 0.20 to 0.50 N/mm².

The extruded polystyrene resin foam of the present invention can be obtained by using a conventional extrusion foaming technique for producing extruded foam in combination with the die construction described below. Specifically, a known nucleating agent such as talc, a known fire retardant such as hexabromocyclodecane, and the polystyrene resin are heated and mixed together within an extruder to prepare a polystyrene resin melt. Next, the above-described physical blowing agent is injected into the extruder and the melt and blowing agent are thoroughly mixed, following which the mixture is cooled to a temperature suitable for foaming, thereby giving an expandable resin melt. The expandable resin melt is then introduced to a die having a cooling member therein and constructed so that a molten resin flow channel within the die is broad in a vertical direction but narrows abruptly near a die orifice, and extrusion foaming the melt by discharging it from the die orifice into a guider attached to a top of the die and causing it to expand within the guider.

In the foregoing description, the gap and width of the die orifice and the width and height dimensions of the guider are suitably selected based on such considerations as the thickness and apparent density desired for the extruded foam. In the production method described above, in addition to the nucleating agent and fire retardant mentioned above, various other additives, including colorants, thermal stabilizers and fillers, may be suitably added within ranges that do not compromise the objects and advantages of the present invention.

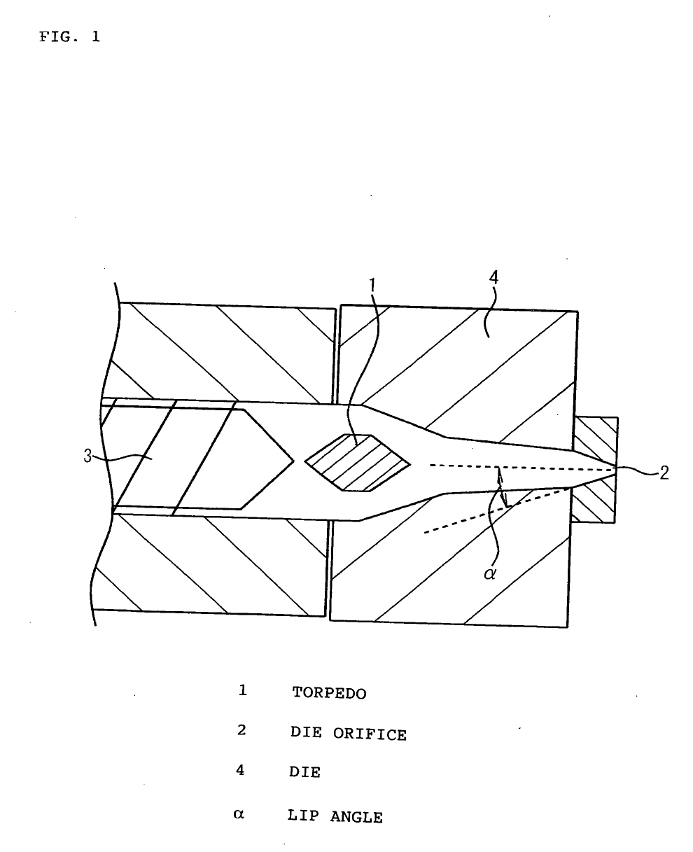

The extruded foam of the present invention which satisfies above conditions (1) to (5) can be produced by, in the above-described extrusion foaming process, adjusting the resin temperature near the center of the foam in the thickness direction so as to reduce the temperature difference between the vicinity of the center portion and the vicinity of the surfaces when the expandable resin melt is discharged from the die orifice into the guider and thereby foamed. Adjustment of the resin temperature near the center of the foam so as to reduce the temperature difference between the vicinity of the center portion and the vicinity of the surfaces when the melt is discharged into the guider and thereby foamed can be achieved as follows. That is, extrusion of the expandable resin melt can be achieved by using a cooling member such as the torpedo 1 shown in FIG. 1 disposed within the die positioned between the front end of the extruder and the guider to carry out temperature adjustment and by also adjusting the shape of the molten resin flow channel in such a way as to minimize molten resin shear heat and maintain the pressure within the die at a level suitable for extrusion foaming.

In conventional extrusion technology, the torpedo is used to cool the molten resin or to maintain pressure within the die by narrowing the resin flow channel. However, in the present invention, the torpedo or other cooling member within the die used to obtain the extruded foam serves mainly to render the temperature of the expandable resin melt uniform. When a cooling member such as a torpedo is employed to obtain the extruded foam of the present invention, attempts to maintain the pressure within the die by means of this cooling member may have the effect of excessively cooling the molten resin, causing the viscosity of the expandable resin melt to rise more than necessary and compromising the expandability so that an extruded foam having a thickness and apparent density according to the present invention may not be achieved.

Accordingly, in the practice of the present invention, along with providing the above cooling member within the die, it is important to also suppress molten resin shear heat and maintain pressure within the die by widening the vertical gap of the molten resin flow channel within the die and abruptly narrowing the gap near the die orifice.

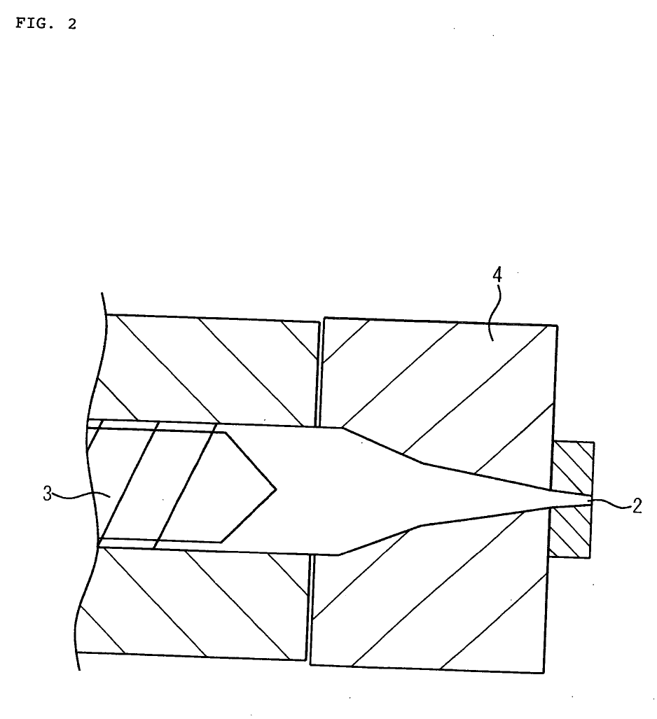

FIG. 1 shows the construction of a die for manufacturing the extruded foam of the present invention, and FIG. 2 shows the construction of a prior-art die used for producing prior-art extruded foams. FIG. 1 is a partial longisectional view showing an example of a die construction for manufacturing the extruded foam of the present invention. In the die construction shown in FIG. 1, a torpedo 1 is provided at the interior of the die 4, the resin flow channel is formed wider than in the prior-art die construction shown in FIG. 2, and this resin flow channel narrows abruptly near the die orifice 2. The die construction in FIG. 1 is preferably such that the region near the die orifice 2 where the resin flow channel abruptly narrows (rapid compression region) has a lip angle α of preferably 15 to 35 degrees, and more preferably 20 to 30 degrees. Also, it is desirable for the torpedo 1 to be adjusted to a temperature of preferably 80 to 115° C., and more preferably 85 to 90° C. If the torpedo 1 is adjusted to a temperature that is too high, it will not be possible to obtain an extruded foam of the desired cellular construction. By setting the temperature of the torpedo 1 at the low end within the above range, the above-described microcellular layer can be formed in the center layer of the extruded foam.

The cell diameter values D_{VD}, D_{TD} and D_{MD} in the center layer of the above-described extruded foam can be determined as follows.

To determine D_{VD} (μm) and D_{TD} (μm), a vertical cross-section in the transverse direction of the extruded foam (vertical cross-section orthogonal to machine direction of foam plank) from which portions accounting for 10% of the extruded foam thickness have been removed from either surface of the extruded foam is enlarged using a suitable device such as a microscope and projected onto a screen or monitor. Similarly, to determine D_{MD} (μm), a vertical cross-section in the machine direction (a vertical cross-section which divides the extruded foam plank into two equal halves in the transverse direction and is orthogonal to the transverse direction of the foam) of the extruded foam from which portions accounting for 10% of the extruded foam thickness have been removed from either surface of the extruded foam is enlarged using a suitable device such as a microscope and projected onto a screen or monitor. The average cell diameter in each direction is then obtained by drawing a straight line on the appropriate projected image in the direction to be measured, counting the number of cells which intersect the line, and dividing the length of the line (here, “length” refers not to the length of the straight line on the enlarged and projected image, but rather to the true length of the straight line that takes into account the degree of magnification of the projected image) by the number of counted cells. The methods for obtaining these values are described more specifically below.

(a) The average cell diameter in the thickness direction (D_{DV}) is measured by drawing straight lines extending the full thickness of the center layer in the thickness direction at a total of three places, namely, at the center and near both ends of a vertical cross-section in the transverse direction; determining the average diameter of cells present on each line from the length (μm) of each line and the number of cells intersecting that straight line minus one ((length of straight line (μm))/(number of cells intersecting line−1)), and treating the arithmetic average of the resulting average diameters at the three places as the average cell diameter in the thickness direction (D_{VD}).

(b) The average cell diameter in the transverse direction (D_{TD}) is measured by drawing in the transverse direction, and at a position which bisects the foam in the thickness direction, straight lines having a length of 3,000 μm at a total of three places, namely, at the center and near both ends of a vertical cross-section in the transverse direction; determining the average diameter of cells present on each line from the 3,000 μm length of the line and the number of cells intersecting that straight line minus one ((3,000 μm)/(number of cells intersecting line−1)), and treating the arithmetic average of the resulting average diameters at the three places as the average cell diameter in the transverse direction (D_{TD}).

(c) The average cell diameter in the machine direction (D_{MD}) is measured by drawing in the machine direction, and at a position which bisects the foam in the thickness direction, straight lines having a length of 3,000 μm at a total of three places, namely, at the center and near both ends of a vertical cross-section in the machine direction; determining the average diameter of cells present on each line from the 3,000 μm length of the line and the number of cells intersecting that straight line minus one ((3,000 μm)/(number of cells intersecting line−1)), and treating the arithmetic average of the resulting average diameters at the three places as the average cell diameter in the machine direction (D_{MD}).

Because the center layer in a cross-section perpendicular to the machine direction of the extruded foam of the present invention also includes therein one or a plurality of microcellular layers which extend in the transverse direction, the D_{VD}, D_{TD} and D_{MD} values for the center layer in such an extruded foam are measured separately for the microcellular layer and for the rest of the center layer, but satisfy above-described conditions (1) and (2) in each.

(d) The average cell diameter in the thickness direction (D_{VD}) within the microcellular layer is measured by drawing straight lines extending the full thickness of the microcellular layer (generally about 1 to 10 mm) in the thickness direction at a total of three places, namely, at the center portion and near both ends of the microcellular layer in a vertical cross-section in the transverse direction; determining the average diameter of cells present on each line from the length (μm) of each line and the number of cells intersecting that straight line minus one ((length of straight line (μm))/(number of cells intersecting line−1)), and treating the arithmetic average of the resulting average diameters at the three places as the average cell diameter in the thickness direction (D_{VD}) within the microcellular layer.

(e) The average cell diameter in the transverse direction (D_{TD}) within the microcellular layer is measured by drawing in the transverse direction, and at a position which bisects the microcellular layer in the thickness direction, straight lines having a length of 3,000 μm at a total of three places, namely, at the center portion and near both ends of the microcellular layer in a vertical cross-section in the transverse direction; determining the average diameter of cells present on each line from the 3,000 μm length of the line and the number of cells intersecting that straight line minus one ((3,000 μm)/(number of cells intersecting line−1)), and treating the arithmetic average of the resulting average diameters at the three places as the average cell diameter in the transverse direction (D_{TD}) within the microcellular layer.

(f) The average cell diameter in the machine direction (D_{MD}) within the microcellular layer is measured by drawing in the machine direction, and at a position which bisects the microcellular layer in the thickness direction, straight lines having a length of 3,000 μm at a total of three places, namely, at the center portion and near both ends of the microcellular layer in a vertical cross-section in the machine direction; determining the average diameter of the cells present on each line from the 3,000 μm length of the line and the number of cells intersecting that straight line minus one ((3,000 μm)/(number of cells intersecting line−1)), and treating the arithmetic average of the resulting average diameters at the three places as the average cell diameter in the machine direction (D_{MD}) within the microcellular layer. In an extruded foam containing a microcellular layer in the center layer, the D_{VD}, D_{TD} and D_{MD} values for portions of the center layer other than the microcellular layer are measured in the same way as described in (d) to (f) above.

In an extruded foam according to the present invention having one or more microcellular layer formed therein, the average cell diameter in the thickness direction for the center layer as a whole refers to the value determined by the measurement method described above in (a), and the average cell diameter in the thickness direction for the microcellular layer refers to the value determined by the measurement method described above in (d).

The compressive strength values P_{VD}, P_{TD} and P_{MD} in the present invention can be determined as follows. A cubical test specimen is cut from the center of the extruded foam to a length (machine direction of extruded foam) of 45 mm, a width (transverse direction of extruded foam) of 45 mm and a thickness (thickness direction of extruded foam) of 45 mm. Aside from setting the test rate to 10 mm/min, as described in JIS K7220 (1999) the test specimen is compressed in the machine, transverse and thickness directions of the extruded foam, the load during 5% compression is determined, and the compressive strength is calculated using a specific formula. A new test specimen is used for each measurement; the same specimen is not repeatedly used in measurements.

The extruded polystyrene resin foam of the present invention is an extruded foam plank which is used primarily as a construction material and a civil engineering material. Given the desire for thick foam planks for reasons having to do with the intended applications and production efficiency, and given the difficulty of achieving uniform mechanical properties and dimensional stability, the thickness of the extruded foam plank is 45 to 150 mm, preferably more than 50 mm and up to 150 mm, and most preferably from 55 to 120 mm. If the extruded foam plank is too thin, when employed as a civil engineering material, several sheets will have to be stacked and tied together for use. Moreover, in terms of the physical properties, the mechanical strength such as flexural strength is likely to be inadequate. On the other hand, very thick extruded foam having a thickness greater than 150 mm requires a very large manufacturing facility, resulting in high production costs. Moreover, control of the cell diameter and shape is difficult, which may make it impossible to achieve uniform mechanical properties in all directions.

In areas of application requiring a particularly thick expanded material such as civil engineering-related construction materials and large-thickness thermal insulation, it has been impossible to satisfy most such needs other than with molded polystyrene beads foam. However, the extruded foam of the present invention has a thickness of 45 to 150 mm and a good balance of mechanical properties in the machine, transverse and thickness directions, making it highly suitable for applications involving use as civil engineering-related construction materials and thick thermal insulation. By taking advantage of the uniformity of the mechanical properties in all directions and subjecting it to fabrication such as cutting and slicing, the extruded foam of the present invention can of course be used in existing thermally insulating foam plank applications, but can be used in many other ways as well. Furthermore, because the extruded foam of the present invention is produced by an extrusion foaming process, a resin layer, called the “skin layer,” having a high density compared to the apparent density at the foam interior forms at the surfaces of the foam. This skin layer is sometimes removed by cutting and finishing the extruded foam. Hence, the extruded polystyrene resin foam described in the claims of the present invention is targeted at an extruded polystyrene resin foam which has a specific thickness and apparent density and which, regardless of the presence or absence of skin layers, satisfies specific cell diameter ratios and physical properties.

For the extruded foam of the present invention to be suitable as extruded foam planks in the foregoing applications, it must have a low apparent density of 0.015 to 0.06 g/cm³, preferably 0.020 to 0.045 g/cm³, and more preferably 0.02 to 0.038 g/cm³. The apparent density of the extruded foam in the present invention is a value measured in accordance with JIS A9511 (2003).

It is preferable for the center layer of the extruded foam of the present invention to have, in a cross-section perpendicular to the machine direction, an average cell diameter in the thickness direction for the center layer as a whole of from 70 to 700 μm and to include at least one microcellular layer having an average cell diameter in the thickness direction within the center layer that is from 50 to 500 μm and less than the average cell diameter in the thickness direction of the center layer as a whole. Moreover, the average cell diameter in the thickness direction for the microcellular layer is preferably 50 to 90%, and more preferably 60 to 85%, of the average cell diameter in the thickness direction for the center layer as a whole.

In an extruded foam of the present invention having a distinctive cell construction such as the above, one or more microcellular layer having an average cell diameter of 50 to 500 μm in the thickness direction within the center layer can be formed by, in the above-described extrusion foaming according to the present invention, disposing a cooling member such as a torpedo at the die interior and carrying out extrusion foaming while adjusting the temperature of the cooling member in accordance with the resin temperature to a temperature 15 to 35° C. lower than the temperature to which the die is adjusted. Moreover, by providing within the die a plurality of cooling members in the vertical direction, two or more microcellular layers can be formed. The extruded foams of the present invention with such a distinctive cell structure have further improved thermal insulating properties owing to the existence of these microcellular layers.

The extruded foam of the present invention has thermal insulating properties characterized by a thermal conductivity of preferably 0.02 to 0.04 W/m·K, and has mechanical properties characterized by a compressive strength in the thickness direction of preferably 0.15 to 0.80 N/mm², and more preferably 0.20 to 0.50 N/mm², and a flexural strength in the machine and transverse directions of preferably 0.20 to 1.00 N/mm². Moreover, the extruded foam has a (flexural strength in transverse direction)/(flexural strength in machine direction) ratio of preferably 0.80 to 1.20, and more preferably 0.90 to 1.15.

The flexural strength of the extruded foam used in the practice of the present invention is obtained by cutting from the center portion of the extruded foam a test strip measuring 300 mm long (machine or transverse direction of extruded foam), 75 mm wide and having the thickness of the extruded foam, setting the test rate at 10 mm/min, and computing the maximum flexural strength in the machine or transverse direction of the extruded foam in accordance with JIS K7221-2 (1999). The flexural strength in the machine direction is the maximum flexural strength determined using a test strip which has been cut so that the length direction of the strip coincides with the machine direction of the extruded foam. Similarly, the flexural strength in the transverse direction is the maximum flexural strength determined using a test strip which has been cut so that the length direction of the strip coincides with the transverse direction of the extruded foam.

In the practice of the present invention, the thermal conductivity of the extruded foam is the value measured based on the flat plate heat flux measurement method (two flowmeter technique; high-temperature side, 35° C.; low-temperature side, 5° C.; average temperature, 20° C.) described in JIS A 1412 (1994), in accordance with 4.7 in JIS A 9511 (1995).

The extruded foam of the present invention is illustrated more fully in the following examples.

### EXAMPLES 1 TO 5

An extruder for producing extruded foam was used. The extruder had a die construction according to the embodiment shown in FIG. 1, which included a torpedo disposed at the interior of the die.

Polystyrene (manufactured by Japan Polystyrene, Inc. under Product No. “HH32”) and a nucleating agent master batch and a fire retardant master batch in the respective amounts per 100 parts by weight of polystyrene shown in row a (“Additives”) of Table 1 were fed to an extruder, melted and kneaded. Next, isobutane and methyl chloride in the molar amounts per kilogram of polystyrene shown in row b (“Amounts of blowing agents”) of Table 1 were introduced into the molten mixture through a blowing agent injection port provided on the extruder and mixed with the melt, and the resin temperature was adjusted to the temperature shown in row c (“Resin temperature”) of Table 1. The resin was then extruded at a low pressure by being passed through a die adjusted to the same temperature as the resin temperature and having situated therein a torpedo through which an oil adjusted to the temperature shown in row d (“Oil temperature”) of Table 1 was circulated. The width, gap and die lip angle α toward the die orifice provided at the front end of the die were set at the values indicated in row e (“Die orifice”) of Table 1. The expandable melt resin mixture extruded was molded into a plank by being allowed to expand and at the same time allowed to move in a fully filled state through a guider connected to the downstream side of the die orifice, yielding an extruded polystyrene resin foam plank of the dimensions shown in row f (“Extruded foam dimensions”) of Table 1.

The extruded foam obtained in Examples 1 to 5, for at least 90% (number basis) of the cells in the center layer present within a vertical cross-section in the machine direction or transverse direction of the foam, had a (thickness direction cell diameter)/(machine direction cell diameter) ratio of at least 0.80 but less than 1.20 and a (thickness direction cell diameter)/(transverse direction cell diameter) ratio of at least 0.80 but less than 1.20, and thus exhibited excellent cell shape uniformity. Moreover, in the extruded foams obtained in Examples 1 to 5, 24 hours after production of the foam, dimensional shrinkage at both ends and the center in the machine direction was 3 mm and dimensional changes were not observed in the thickness and transverse directions. Hence, the extruded foam had excellent dimensional stability. In the extruded foams obtained in Examples 2 to 5, one microcellular layer having a width of about 2 mm in the thickness direction formed at a position in a cross-section perpendicular to the machine direction which bisected the center layer vertically. The physical properties of the extruded foams obtained in Examples 1 to 5 are shown in Table 2.

### COMPARATIVE EXAMPLES 1 AND 2

Aside from carrying out extrusion foaming under the conditions shown in Table 1 and using a die which was not equipped with a torpedo and had the construction shown in FIG. 2, extruded foams were obtained in the same way as in the above examples of the present invention. Here, Comparative Example 1 corresponds with above Example 1, and Comparative Example 2 corresponds with above Example 5. The extruded foams obtained in Comparative Examples 1 and 2 had cell shapes in the center layer which were elongated in the thickness direction. Twenty four hours after production, the extruded foams obtained in Comparative Examples 1 and 2 had undergone a dimensional shrinkage at both ends in the machine direction of 6 mm, and a dimensional shrinkage in the center of 4 mm. Compared with the extruded foams obtained in the examples of the present invention, the amount of shrinkage was large, the shrinkage dimensions between the ends and the center were poorly balanced, and the dimensional stability was poor. The physical properties of these extruded foams are shown in Table 2.

The nucleating agent master batch used in the examples of the present invention and the comparative examples was composed of 40 wt % polystyrene and 60 wt % talc. The fire retardant master batch used in the examples was composed of 50 wt % polystyrene and 50 wt % hexabromocyclododecane.

TABLE 1

| | | Units | EX 1 | EX 2 | EX 3 | EX 4 | EX 5 | CE 1 | CE 2 |
|---|---|---|---|---|---|---|---|---|---|
| Torpedo (yes/no) | | — | yes | yes | yes | yes | yes | no | no |
| a) Additives | Nucleating agent master batch | phr | 5.0 | 5.0 | 5.0 | 5.0 | 1.0 | 5.0 | 1.0 |
| | Fire retardant master batch | phr | 8.0 | 8.0 | 8.0 | 8.0 | 4.0 | 8.0 | 4.0 |
| b) Amounts of | Isobutane | mol/kg | 0.55 | 0.55 | 0.55 | 0.55 | 0.26 | 0.55 | 0.26 |
| blowing agents | Methyl chloride | mol/kg | 0.5 | 0.5 | 0.5 | 0.5 | 1.2 | 0.5 | 1.2 |
| c) Resin | — | ° C. | 120 | 120 | 120 | 120 | 120 | 120 | 120 |
| temperature | | | | | | | | | |
| d) Oil | — | ° C. | 110 | 90 | 95 | 100 | 100 | — | — |
| temperature | | | | | | | | | |
| e) Die | Width | mm | 450 | 450 | 500 | 550 | 550 | 450 | 550 |
| orifice | Gap | mm | 4.0 | 4.4 | 6.0 | 8.0 | 8.0 | 4.0 | 8.0 |
| | Lip angle α | degrees | 25 | 25 | 25 | 25 | 25 | 10 | 10 |
| f) Extruded | Thickness | mm | 52 | 58 | 77 | 103 | 103 | 52 | 103 |
| foam | Width | mm | 1000 | 1000 | 1000 | 1000 | 1000 | 1000 | 1000 |
| dimensions | length | mm | 1850 | 1850 | 1850 | 1850 | 1850 | 1850 | 1850 |

phr: parts by weight per 100 parts by weight of polystylene

TABLE 2

| | | | Units | EX 1 | EX 2 | EX 3 | EX 4 | EX 5 | CE 1 | CE 2 |
|---|---|---|---|---|---|---|---|---|---|---|
| Thickness | | | mm | 52 | 58 | 77 | 52 | 103 | 52 | 103 |
| Apparent density | | | g/cm³ | 0.038 | 0.038 | 0.037 | 0.038 | 0.026 | 0.037 | 0.026 |
| Average | No | D_{TD} | μm | 193 | — | — | — | — | 222 | 400 |
| cell | microcellular | D_{MD} | μm | 187 | — | — | — | — | 211 | 364 |
| diameter | layer | D_{VD} | μm | 187 | 178* | 192* | 200* | 378* | 286 | 571 |
| and | | D_{VD}/D_{TD} | — | 0.97 | — | — | — | — | 1.29 | 1.43 |
| cell | | D_{VD}/D_{MD} | — | 1.00 | — | — | — | — | 1.36 | 1.57 |
| diameter | Microcellular | D_{TD} | μm | — | 138 | 148 | 154 | 286 | — | — |
| ratio | layer present: | D_{MD} | μm | — | 154 | 159 | 167 | 250 | — | — |
| in | Microcellular | D_{VD} | μm | — | 133 | 158 | 167 | 267 | — | — |
| center | layer | D_{VD}/D_{TD} | — | — | 0.97 | 1.07 | 1.08 | 0.93 | — | — |
| layer | | D_{VD}/D_{MD} | — | — | 0.87 | 1.00 | 1.00 | 1.07 | — | — |
| | Microcellular | D_{TD} | μm | — | 182 | 180 | 180 | 333 | — | — |
| | layer present: | D_{MD} | μm | — | 211 | 187 | 174 | 323 | — | — |
| | Cell layer other | D_{VD} | μm | — | 179 | 193 | 201 | 381 | — | — |
| | than microcellular | D_{VD}/D_{TD} | — | — | 0.98 | 1.07 | 1.12 | 1.14 | — | — |
| | layer | D_{VD}/D_{MD} | — | — | 0.85 | 1.04 | 1.16 | 1.18 | — | — |
| Compressive strength | | P_{TD} | N/mm² | 0.38 | 0.35 | 0.28 | 0.26 | 0.26 | 0.25 | 0.15 |
| and | | P_{MD} | N/mm² | 0.37 | 0.36 | 0.27 | 0.22 | 0.19 | 0.22 | 0.13 |
| Compressive strength ratio | | P_{VD} | N/mm² | 0.31 | 0.32 | 0.30 | 0.46 | 0.38 | 0.55 | 0.31 |
| | | (P_{TD} + P_{MD} + | — | 1.15 | 1.06 | 0.96 | 0.73 | 0.75 | 0.62 | 0.63 |
| | | P_{VD})/3P_{VD} | | | | | | | | |
| | | (P_{TD} + P_{MD} + | — | 0.92 | 0.98 | 1.01 | 1.25 | 1.23 | 1.36 | 1.31 |
| | | P_{VD})/3P_{TD} | | | | | | | | |
| | | (P_{TD} + P_{MD} + | — | 0.96 | 0.96 | 1.04 | 1.21 | 1.17 | 1.55 | 1.51 |
| | | P_{VD})/3P_{MD} | | | | | | | | |
| Flexural strength | | MD | N/mm² | 0.70 | 0.69 | 0.71 | 0.72 | 0.44 | 0.69 | 0.40 |
| and | | TD | N/mm² | 0.65 | 0.70 | 0.70 | 0.65 | 0.38 | 0.54 | 0.32 |
| Flexural strength ratio | | MD/TD | — | 1.08 | 0.99 | 1.01 | 1.11 | 1.16 | 1.28 | 1.25 |
| Thermal conductivity | | | W/m · K | 0.025 | 0.025 | 0.025 | 0.026 | 0.036 | 0.028 | 0.039 |
| Remaining gases | | Type | — | isobutane | isobutane | isobutane | isobutane | isobutane | isobutane | isobutane |
| | | Amount | mol/kg | 0.52 | 0.52 | 0.53 | 0.53 | 0.22 | 0.52 | 0.22 |

*Average cell diameter in thickness direction of center layer as a whole
In the table, MD stands for machine direction,
TD stands for transverse direction, and
VD stands for thickness direction.

1. An extruded polystyrene resin foam which contains a residual gas selected from fluorohydrocarbons, aliphatic hydrocarbons and alicyclic hydrocarbons and has a thickness of 45 to 150 mm and an apparent density of 0.015 to 0.06 g/cm³, wherein the foam comprises a center layer which, exclusive of portions accounting for 10% of the foam thickness from each of two foam surfaces, is composed of cells with a shape that satisfies formulae (1) and (2) below, and has compressive strengths in foam thickness, transverse and machine directions which satisfy formulae (3) to (5) below:
0.80≦D_{VD}/D_{TD}<1.20 (1)
0.80≦D_{VD}/D_{MD}<1.20 (2)
0.65≦(P_{VD}+P_{TD}+P_{MD})/3P_{VD}≦1.40 (3)
0.80≦(P_{VD}+P_{TD}+P_{MD})/3P_{TD}≦1.50 (4)
0.80≦(P_{VD}+P_{TD}+P_{MD})/3P_{MD}≦1.50 (5)
where D_{VD} is the average diameter of cells within the center layer in the thickness direction, D_{TD} is the average diameter of cells within the center layer in the transverse direction, D_{MD} is the average diameter of cells within the center layer in the machine direction, P_{VD} is the compressive strength of the foam in the thickness direction, P_{TD} is the compressive strength of the foam in the transverse direction, and P_{MD} is the compressive strength of the foam in the machine direction.

2. The extruded polystyrene resin foam of claim 1, wherein the center layer, within the center layer in a cross-section perpendicular to the machine direction, has an average cell diameter in the thickness direction for the center layer as a whole of from 70 to 700 μm and includes at least one microcellular layer having an average cell diameter in the thickness direction within the center layer that is from 50 to 500 μm and less than the average cell diameter in the thickness direction for the center layer as a whole.

3. The extruded polystyrene resin foam of claim 1, containing no residual gases comprising fluorohydrocarbons in the foam.

4. The extruded polystyrene resin foam of claim 1, wherein a thermal conductivity is 0.02 to 0.04 W/m·K, and a compressive strength in the thickness direction is 0.15 to 0.80 N/mm².

5. The extruded polystyrene resin foam of claim 1, the polystyrene resin foam with a thickness of 45 to 150 mm and an apparent density of 0.015 to 0.06 g/cm³ being obtained by introducing an expandable resin melt, which is prepared by melting and mixing together a polystyrene resin, additives and a blowing agent within an extruder, into a die, which has a cooling member therein and is configured so that a molten resin flow channel within the die is broad in a vertical direction but narrows abruptly near a die orifice, and by extrusion foaming the melt by discharging it from the die orifice into a guider attached to a tip of the die, wherein
the foam comprises a center layer which, exclusive of portions accounting for 10% of the foam thickness from each of two foam surfaces, is composed of cells with a shape that satisfies formulae (1) and (2) above, and has compressive strengths in foam thickness, transverse and machine directions which satisfy formulae (3) to (5) above.

6. The extruded polystyrene resin foam of claim 5, wherein a lip angle α of a portion narrowing abruptly near the die orifice is 15 to 35 degrees.
